(19) United States
(12) Patent Application Publication
(10) Pub. No.: US 2010/0151086 A1
(43) Pub. Date: Jun. 17, 2010

(54) Powdered Sauces And Uses Thereof

(75) Inventors: Adalgiza Sonia Salais, Memphis, TN (US); Thomas H. Rieman, Bartlett, TN (US); Charles Allen Rodgers, Memphis, TN (US)

Correspondence Address: FITCH EVEN TABIN & FLANNERY, 120 SOUTH LASALLE STREET, SUITE 1600, CHICAGO, IL, 60603-3406, US

(73) Assignee: KRAFT FOODS GLOBAL BRANDS LLC, Northfield, IL (US)

(21) Appl. No.: 12/634,483

(22) Filed: Dec. 9, 2009

Related U.S. Application Data
(60) Provisional application No. 61/122,211, filed on Dec. 12, 2008.

(51) Int. Cl. A23L 1/212; A23L 1/0522; A23L 1/053; A23L 1/39

(52) U.S. Cl. 426/96; 426/290

(57) ABSTRACT

A frozen food that is suitable for heating to form a food and sauce combination is provided. The food includes frozen food pieces and a powdered sauce composition individually applied to outer surfaces of each frozen food piece so that a fluid sauce of a desired consistency is produced upon heating the food.

### CROSS-REFERENCE TO RELATED APPLICATION

This application claims benefit of U.S. Provisional Application No. 61/122,211, filed Dec. 12, 2008, which is hereby incorporated herein by reference in its entirety.

### FIELD

The field relates to powdered sauces, and in particular, powdered sauces applied to individual frozen food pieces suitable to form a fluid sauce upon heating.

### BACKGROUND

Frozen foods can provide a quick and easy way for consumers to prepare meals or side dishes. Such frozen foods may include a variety of vegetables, pastas, proteins (such as chicken or beef), or combinations thereof. Often, these frozen foods are paired with a liquid sauce, such as cheese, gravy, dressing, topping or other such coatings. The sauce is often manufactured separately as a liquid, frozen into a quantity proportionate to the amount of frozen food to be used, and subsequently packaged with that frozen food for sale to consumers. During preparation, the consumer applies a heat source to the combination of the frozen food and sauce. As the frozen food cooks, the separate sauce source melts and results in a sauce-coated meal or side dish.

In some cases, it is common for the sauce to be frozen into a disc-shape or relatively large sized chunk(s). However, if a consumer wants to prepare less than the entire package of the frozen food, the consumer would have to break up the relatively large disc of sauce into smaller pieces prior to heating the food, which is often a difficult and messy task that does not always result in the correct sauce-to-food ratio. This sauce-portioning process generally involves a fair amount of guessing by the consumer as to the appropriate amount of frozen sauce to be cut from the relatively large disc for use with the chosen quantity of frozen food. Often, the consumer may over or under estimate the proper amount of frozen sauce to use for the selected portion of food, resulting in an unsatisfactory ratio of food to sauce in the meal or side dish. Additionally, if an incorrect quantity of sauce was used in preparing the first portion of frozen food, subsequent portions would likewise be affected.

In other cases, the sauce can be frozen in smaller portions, such as cube- or chip-sized chunks. These smaller sauce pieces can save a consumer seeking to portion-control from the messy undertaking associated with breaking up the relatively large disc of sauce. However, when preparing less than the full package of frozen food, the consumer is still left to guess at the quantity of frozen sauce pieces to include with the frozen food, creating the same problems as discussed above when trying to portion the meal or side dish using the large sauce chunks. For instance, if the consumer includes too many small sauce chips in the portion to be prepared, then the remaining unused frozen food portion would be left with too little sauce. Likewise, if not enough frozen sauce chips are selected, then the remaining frozen food portion would have too much sauce and the cooked portion would have less than the desired amount of sauce.

When using either of these prior methods, consumers may also be required to add additional moisture to achieve the appropriate sauce consistency. Often, the pre-prepared sauce poorly hydrates during heating resulting in a thick sauce. As a result, consumers may be required to add and mix water, vegetable oil, or other liquid to the frozen food and sauce before the side dish or meal was ready for consumption to achieve proper sauce consistency, which adds additional processing steps to the preparation of such meals. In both methods, consumers may also need to mix the sauce and frozen food together to ensure that the sauce is evenly distributed and coated upon the heated food.

Cheese powders are commonly used in some shelf-stable products, for example, as a seasoning for dry snacks or as a base in making separate cheese sauces. When used in the dry snack applications, the cheese powder may be applied to the dry snack with the use of an additional adherent ingredient, such as an oil or fat source, that is applied to the snack prior to the cheese powder to ensure that the powder adheres to the surface of the dry snack. Important to this dry snack process is that a minimal amount of moisture is introduced, as the snack's shelf-stability comes from the presence of about 5 percent or less moisture. Thus, it has been previously difficult to use cheese powders designed for dry snacks in applications using moist or frozen foods because these prior dry snack cheese powders are generally not formulated for use in elevated water activity circumstances or even to make a fluid sauce, but simply provide flavoring to dry snacks.

### SUMMARY

A frozen food and a method of preparing and using the frozen food are provided. In general, the frozen food is suitable for heating or reheating to form a food and fluid sauce combination. In one aspect, the frozen food includes a plurality of frozen food pieces, such as vegetables, pasta, protein, and the like or combinations thereof, and an amount of a powdered sauce composition applied and adhered to outer surfaces of each of the plurality of frozen food pieces. By one approach, the frozen food pieces generally have an amount of frozen moisture sufficient to hydrate the powdered sauce composition applied to each individual piece into a fluid sauce having a sauce-like consistency sufficient for that single food piece and, preferably, without the need to add additional water. The frozen food combinations herein are advantageous because each frozen food piece is individually coated with the appropriate amount of powdered sauce composition to form a fluid sauce. As a result, a consumer may select any portion or all of the frozen food assembly without having to guess at the correct amount of sauce needed for the selected food portion because each individual food piece has the correct amount of powdered sauce composition already applied thereto for that piece. Preferably, the powdered sauce composition is uniformly applied or coated about the outer surface of the frozen food piece and has a composition to produce a fluid sauce based solely on the retained moisture in the particular frozen food piece.

By using the frozen food assembly described herein, a consumer seeking to portion-control a package containing a plurality of frozen food pieces no longer needs to sort through chunks of sauce (or cut up chunks of sauce) and guess what amount of frozen sauce is necessary to achieve the correct ratio of food-to-sauce. Rather, since each piece of frozen food as provided herein has an effective amount of the powdered sauce composition adhered thereto to form a sauce, a consumer may simply select any quantity, from just a single piece up to the entire contents of a package, and heat or warm such selected quantity to prepare the food with the right amount of fluid sauce. This individual powdered sauce composition adhered to the surface of each food piece also leaves the correct amount of sauce composition for any remaining, unselected portion of frozen food left in the package. Therefore, when the next portion is prepared, it also preferably will have the correct sauce-to-food ratio.

In another aspect, the powdered sauce composition includes a formulation effective to form a fluid sauce based solely from the moisture in the frozen food piece. By one approach, the powdered sauce composition is a powdered cheese composition. In this approach, the powdered cheese composition may include amounts of casein protein, whey protein, starches, and viscosity builders in a combination effective such that heating at least a portion of the plurality of frozen food pieces having the powdered cheese composition individually applied thereto results in the frozen moisture hydrating the powder into a fluid sauce to substantially coat the outer surface of the heated frozen food pieces. Preferably, no additional moisture is needed to sufficiently hydrate the cheese powder into a sauce. By yet another approach, the powdered sauce composition may include other savory or sweet powdered sauces such as, for example, white or brown gravies, emulsified sauces, butter sauces, sweet sauces, hot sauces, Asian-type sauces, or the like (i.e., gravies, soy/ginger sauces, orange sauces, and the like). By another approach, the powdered sauce composition may be formulated to create a glaze on the frozen food pieces.

In yet another aspect, a method of preparing and using a combination food and sauce meal is provided. In one example of a suitable method, a plurality of frozen food pieces are first provided where each of the frozen food pieces have an outer surface and an amount of frozen moisture. Next, a powdered sauce composition is individually applied to the outer surface of each of the plurality of frozen food pieces either in a partially frozen or frozen condition so that the outer surface is substantially uniformly coated with the powdered sauce composition. Preferably, no additional adherents, oils, fats, or the like are pre-applied or otherwise needed for the powdered sauce to adhere to the frozen food piece. That is, the powdered sauce composition adequately adheres directly to the outer surface so that an interface between the food and powdered sauce composition is substantially free of oils and other fats. Then, the sauce and food combination is obtained by applying heat to at least a portion or all of the plurality of frozen food pieces such that the frozen moisture of the frozen food hydrates the powder into a fluid sauce.

### BRIEF DESCRIPTION OF THE DRAWINGS

FIG. 1 is a picture of a frozen food vegetable medley coated in a cheese powder;

FIG. 2 is a picture of the vegetable medley of FIG. 1 after being heated;

FIG. 3 is a picture of frozen broccoli prior to being coated with a powdered sauce;

FIG. 4 is a picture of the frozen broccoli after being coated with the powdered sauce but prior to being heated;

FIG. 5 is a picture of the frozen broccoli after being heated with the formed sauce; and

FIG. 6 is a flow chart.

### DETAILED DESCRIPTION

A frozen food that is suitable for heating to form a food and sauce combination is provided. In one aspect, the frozen food includes a plurality of frozen food items or pieces, such as (but not limited to) vegetables, pasta, protein (chicken, beef, fish, and the like), or combinations thereof, and an amount of a powdered or particulate sauce composition substantially uniformly applied and adhered to an outer surface of each of the individual pieces or items of frozen food. Upon heating, each frozen food piece generally contains an amount of frozen moisture sufficient to hydrate the adhered powdered sauce composition on that single food piece surface into a fluid sauce having a sauce-like consistency sufficient to form a sauce for that single food piece. By one approach, there is no or little need to add additional water to form the fluid sauce. Preferably, there is also no pre-application of oils or other fats used to adhere the powdered or particulate sauce composition to the frozen food.

Preferably, the powdered sauce composition that individually coats each piece of frozen food in the assembly has a formulation effective to produce a fluid sauce based solely on the retained moisture level for the particular frozen food piece. By one approach, the powdered sauce composition is a powdered cheese composition formed from particulate or granular cheese powders that have increased levels of whey protein relative to casein protein sufficient to minimize the use of starches, gums, and other viscosity builders at low levels. Thus, a cheese-based sauce is formed from more natural cheese-based ingredients (i.e., casein and whey) and less additives. Preferably, such powdered cheese compositions can form a fluid sauce solely from the moisture in the frozen food piece sufficient to form a quantity of sauce for that single food piece.

The powdered or particulate sauce compositions herein also have the correct amount of dry particulate sauce applied and adhered to each frozen food piece sufficient to form the correct sauce-to-food ratio for each individual piece. Thus, a consumer may easily portion-control by selecting any amount (a single piece, for example) or all of the frozen food assembly in a package without having to add additional water or guess at the correct amount of sauce needed for the portion being prepared. To this end, the assembly may be placed in a sealed container and heated to form a food and fluid sauce combination with little or no added water because the moisture already present in the frozen food will sufficiently hydrate the powdered sauce on each individual piece of food with the correct amount of sauce. Advantageously, a single food piece may be prepared in this manner with the correct sauce-to-food ratio without the consumer needing to adjust, add, or select the sauce level for that piece.

In yet another aspect, a method of preparing a combination food and sauce meal or side dish is provided. In one example of a suitable method, a plurality of frozen food pieces is first provided where each of the frozen food pieces has an outer surface and an amount of frozen moisture. An amount of powdered or particulate sauce composition is applied to individual outer surfaces of each of the plurality of frozen food pieces. Preferably, no additional adherents, fats, oils, or the like are needed or pre-applied to the outer surface for the powdered sauce composition to sufficiently adhere to the frozen food piece. The food and particulate combination may then be sealed in a bag or other package. Optionally, the food may be refrozen prior to packaging. Preferably, it is anticipated that there is little to no particulate matter or powder not adhered to a food item in the bag. That is, there is an insubstantial amount of powder at the bottom of the bag as most if not all of the powder is adhered in a substantially uniform manner to the outer surfaces of each of the food pieces. Then, the sauce and food combination is obtained by applying heat, such as by a stove top, grill, microwave, and the like, to at least a portion or all of the plurality of frozen food pieces such that the frozen moisture of the frozen food hydrates the powdered sauce composition into a sauce-like consistency. As mentioned above, no additional water is preferably needed, but may be added as the case may be depending on the particular viscosity of sauce desired.

More specifically, the frozen food includes pieces or items of frozen food. By one approach, the frozen food may include vegetables, pasta, proteins and the like, or any combination thereof, to produce a meal or side dish. Vegetables suitable for use in the meal may include, but are not limited to, artichokes, beans, beets, broccoli, Brussels sprouts, carrots, cauliflower, corn, eggplant, leeks, peas, peapods, peppers, spinach, squash, tomatoes, zucchini, and the like. The frozen food may also include, but is not limited to, any variety of pasta, potatoes, rice, and the like as well as protein sources such as beef, chicken, fish, turkey, and the like. The frozen food may also be used individually or in any combination of the above. It will thus be understood that a meal or side dish can be prepared by selecting a vegetable, starch, protein, and/or combinations thereof, and pairing with it an appropriate powdered sauce composition applied and adhered to the outer surfaces of each individual selected piece of food.

The powdered or particulate sauce composition is applied as a granular powder and adhered to the outer surface of each frozen or partially frozen food piece to substantially uniformly coat the outer surface of each food piece separately. Preferably, the powder is a dry powder having a moisture level of about 4 percent water or less. The amount of powder applied to each piece of frozen food may, in some cases, vary based upon the types and amounts of frozen foods used as each type of frozen food retains and releases different amounts of moisture upon heating. For instance, in comparison to frozen carrots, frozen broccoli tends to release more moisture when heat is applied. Thus, the powdered sauce may, in some cases, be adjusted in either amount or formulation to form a desired sauce with a sauce-like consistency that will adhere to the food piece. To this end, before individually coating some food pieces with the powdered sauce, low levels of starch, viscosity builders, gums, and the like, or combination thereof may be added in appropriate amounts to the powdered sauce to ensure that upon heating, the desired sauce-like consistency will be obtained.

For instance and as described in more details below, the powdered cheese compositions generally have a ratio of casein to whey that is selected to keep the levels of starches, gums, and other viscosity builders to a minimum. By one approach, an effective ratio of casein to whey enables a powdered cheese composition to have no starches, gums, and viscosity builders and, in another approach, an effective ratio of casein to whey enables a powdered cheese composition to have less than about 8.5 percent of starches, gums, and other viscosity builders to be used. In both cases, the compositions still achieve a fluid, sauce-like consistency from a cheese-based powdered sauce adhered to a wide variety of food pieces and obtained solely from the moisture retained in the frozen food with minimal use of non-dairy additives.

By one approach, it is expected that about 5 weight percent powdered sauce composition to about 15 weight percent powdered sauce composition is applied to about 85 weight percent to about 95 weight percent food. In the combinations described herein, this ratio applies both to individual food pieces as well as to a plurality of the food pieces. For example, each individual food item or piece is expected to have between about 5 to about 15 weight percent powdered sauce composition per about 85 to about 85 weight percent food. In general, the amount of powdered sauce composition used may vary based upon several factors, such as the desired flavor and appearance of the sauce, the particular formulation of powdered sauce used, and the type of frozen food pieces. Typically, it is expected that less than about 5 weight percent powdered sauce composition will not give a good flavor or sufficient sauce coating on the food, and greater than 15 weight percent powdered sauce composition will not sufficiently hydrate solely with the moisture from the frozen food item. In one embodiment, a ratio of about 10 weight percent sauce to about 90 weight percent food may be used to produce the correct ratio of sauce to finished product.

In an embodiment directed to cheese sauces, the powdered sauce composition is a powdered, granular, or particulate cheese composition that is preferably hydrated solely by the moisture in the frozen food pieces upon heating to form a fluid cheese sauce. By one approach, the powder includes an effective amount of casein proteins, whey protein, fats, starches, viscosity builders, and a moisture content of about 4 percent or less to form the powdered cheese composition. In this approach, the casein proteins may be provided through one or more powdered cheese bases and the whey may be provided by added whey, such as from whey protein concentrate. While not wishing to be limited by theory, it is believed that in the cheese-based sauces particular ratios of casein and whey protein are effective in achieving the final sauce consistency, adherence properties, and general appearance of the sauce. In one embodiment, a fluid, sauce-like consistency obtained solely from the moisture in the frozen food may be obtained with the applied powdered cheese composition containing about 12 percent to about 26 percent casein protein and about 3 percent to about 6 percent whey protein when the casein to whey amounts are generally maintained within certain ratios.

By one approach, the powdered cheese composition includes at least about four times more casein than whey or a ratio of casein-to-whey of at least about 4:1 or greater. At such ratio of casein to whey, the formulation is effective to adhere to the frozen food pieces with no added fat or oil and is effective to form a fluid, sauce-like consistency solely from the moisture in the frozen food with no added gums, starches, and viscosity builders (such as waxy maize, carboxymethyl cellulose, corn starches, and the like). By another approach, the powered cheese composition includes less casein and more whey in effective ratios (between about 2:1 to about 4:1) that can still achieve a fluid, sauce-like consistency upon reheating solely from the moisture in the food, but at the same time minimizes the amount of the starches, gums, and other viscosity builders to less than about 8.5 percent. In yet a further embodiment, a sauce-like consistency may be obtained wherein the powdered sauce also contains about 14 percent to about 22 percent fat.

In particular embodiments, suitable powdered cheese compositions are provided in Table 1 below. As shown in the table, for cheese sauces the ratio of casein to whey is carefully selected to keep the use of starches, gums, and other viscosity builders to a minimum or to less than about 8.5 percent. Both the examples below sufficiently adhere to the frozen food without any additional oils pre-applied to the food and produced a fluid, sauce-like consistency solely from the frozen food upon reheating. Preferably, no additional moisture is needed to form the sauce.

TABLE 1
Examples of Cheese-based Powdered Sauces

| | | | | Viscosity | Casein:Whey |
|---|---|---|---|---|---|
| | Casein | Whey | Fat | Builders | Ratio |
| A | 25.4% | 3.3% | 21% | 0% | 7.7:1 |
| B | 12.3% | 6.2% | 14.9% | 7.6% | 2:1 |

By one approach, it is believed that a suitable powdered cheese composition can be formed with no starches, gum, and other viscosity builders by using a casein to whey ratio of at least about 4:1 or having at least about four times more casein than whey. By another approach, a powdered cheese composition having a casein-to-whey ratio from about 4:1 to about 8:1 may also be formed that does not have any added starches, gums, and other viscosity builders. In yet another approach, as shown in the table above, less casein can be used and more whey included in the formula. However, it is believed that a ratio of casein to whey between at least about 2:1 to less than about 4:1 is effective to keep the use of the starches, gums, and viscosity builders under about 8.5 percent. Thus, a cheese-based sauce may be obtained that uses mainly dairy-based ingredients and minimizes the use non-dairy ingredients or other additives. For purposes herein, starches, gums, and other viscosity builders may be referred collectively as viscosity builders and include starches (such as, for example, corn starches, amylopectin, waxy maize, and the like), gums (such as, for example, carrageen, pectin, alginate, carob bean gums, gum Arabic, guar gum, xanthan, and the like), maltodextrin, carboxymethyl cellulose, and the like.

The powdered sauce composition may also be varied to create an assortment of other sauces and glazes to be paired with the frozen food pieces. As mentioned above, the powdered sauce composition may be a cheese-based sauce. In another approach, the powdered sauce composition may be a white, brown, emulsified, butter, sweet, hot, Asian sauce or the like. For instance, the sauce may be powdered gravy of any variety such as, for example, sweet and sour sauce, duck sauce, soy sauce, ginger sauce, oyster sauce, Hoisin sauce, Hollandaise sauce, Béarnaise sauce, orange sauce, teriyaki sauce, fish sauce, chili sauce, wine sauce, steak sauce, or the like. The sauce may also be formulated to create a powdered glaze on the individual frozen food pieces. It will be appreciated that these variations are not exclusive, and it will thus be understood that a wide range of dish styles and cuisines may be prepared based upon the sauce chosen.

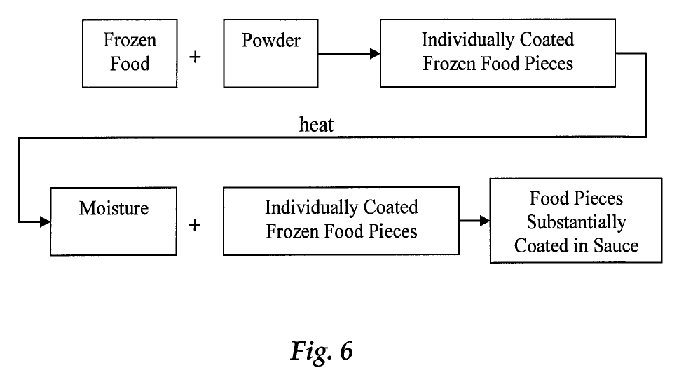

A method of preparing a food coated in a powdered sauce composition is also provided and is generally illustrated in the flow chart of FIG. 6. In one embodiment, a plurality of frozen food, each with an outer surface and an amount of frozen moisture, are first provided and frozen using any convenient freezing method. By one approach, the frozen food pieces may optionally be partially thawed prior to the addition of the powdered sauce. Next, an amount of the powdered or particulate sauce composition is then applied to the outer surface of each of the frozen food pieces by either sprinkling the powdered sauce composition on the individual frozen food pieces or by tumbling an appropriate amount of the powder with the frozen food to substantially uniformly coat and adhere the powder sauce composition to each piece of food separately. If the frozen food is partially thawed, it may then be refrozen to provide a plurality of frozen food pieces individually coated in the powder.

To prepare the food for consumption, a portion (such as at least one piece) or all of individually coated frozen food pieces are selected, and a source of heat is applied. Suitable heat sources include, but are not limited to, a stove top, a grill, a microwave, or the like. The time of heating will vary depending upon the heat source used, and the type of frozen food being prepared. Preferably, the food is reheated according to the commonly used directions to reheat such frozen-food type.

The heat causes the individual frozen food pieces to release their moisture, which in turn hydrates the powdered sauce composition on the individual frozen food pieces into a fluid, sauce-like consistency. Preferably, no additional moisture is added, as the moisture from the frozen food sufficiently hydrates the powder; however, additional moisture, such as water (liquid or frozen), may be added as the case may be, depending upon the particular viscosity of sauce desired by the consumer. After heating, the resultant product is the food and sauce combination that preferably has the sauce substantially coating each piece of food. The methods herein as suitable for heating a single frozen food piece or a plurality of frozen food pieces in the same manner.

Advantages and embodiments of the powdered sauces described herein are further illustrated by the following examples; however, the particular conditions, processing schemes, materials, and amounts thereof recited in these examples, as well as other conditions and details, should not be construed to unduly limit this method. All percentages are by weight unless otherwise indicated.

### Example 1

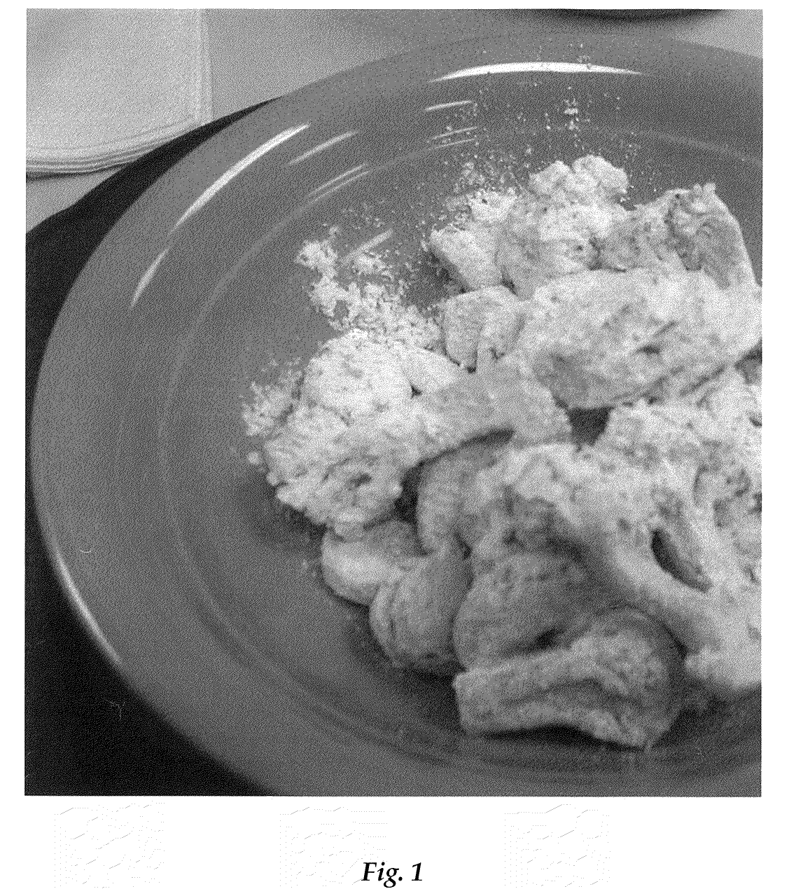

A parmesan cheese powdered sauce composition (Powder 1) was prepared and individually applied to the outer surface of a medley of frozen broccoli, carrots, and cauliflower pieces. Powder 1 was prepared by combining a parmesan cheese base and a concentrated whey protein source in the amounts shown in Table 2 below. All of the ingredients were subsequently spray dried together to produce Powder 1 in the form of a granular and flowable powder. Powder 1 had about 21 percent fat, about 3.3 percent whey protein, and about 25.4 percent casein protein. This formulation had a ratio of casein to whey of 7.6:1 and included no starches, gums, and viscosity builders. Powder 1 was then sprinkled onto the outer surfaces of the vegetable medley, in a ratio of about 10 percent powder to about 90 percent vegetables, based on total weight. The individually coated vegetable pieces with Powder 1 are shown in the photograph of FIG. 1 prior to being heated.

TABLE 2
Formulation for Powder 1

| Ingredient | Amount |
|---|---|
| Parmesan Cheese Base | 59.9% |
| Concentrated Whey | 25.8% |
| Buttermilk Solids | 10% |
| Disodium phosphate | 2.3% |
| Salt | 1.9% |
| Water | 32% |

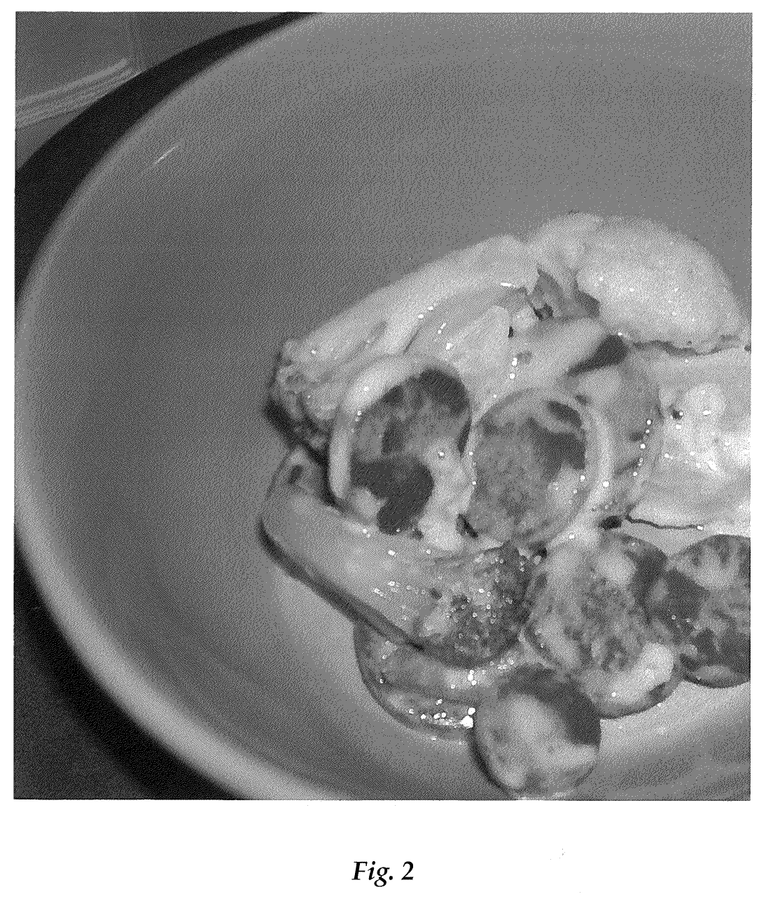

The individually coated vegetable pieces were then heated in a microwave. The powdered sauce was hydrated by the moisture released from the vegetables and produced a cheese sauce that substantially coated and adhered to each individual vegetable piece as shown in the photograph of FIG. 2. No additional moisture was added during heating. Powder 1 forms an acceptable sauce-like consistency upon heating.

### Comparative Example 1

A cheese powder composition (Powder 2) was prepared and applied to frozen broccoli pieces. Powder 2 was prepared by combining a cheese base and a concentrated whey source in the amounts shown in Table 3 below. All of the ingredients were subsequently spray dried together to produce Powder 2 in the form of a granular flowable powder. Powder 2 had about 12 percent fat, about 6.6 percent whey protein, and about 12.8 percent casein protein. This formulation had a ratio of casein to whey of 1.9:1 and had no starches, gums, and viscosity builders. Powder 2 was then sprinkled onto partially thawed individual broccoli pieces, in a ratio of about 10 percent powder to about 90 percent broccoli, based on total weight.

The individually coated broccoli pieces with Powder 2 were then heated in a microwave. Upon applying heat, Powder 2 was hydrated, but resulted in an unacceptable runny sauce that did not adhere to the individual broccoli pieces.

TABLE 3
Formulation for Powder 2

| Ingredient | Amount |
|---|---|
| Concentrated whey | 33.5% |
| Cheese base | 24% |
| Buttermilk solids | 17% |
| Whey protein concentrate | 17% |
| Salt | 5% |
| Disodium phosphate | 2.6% |
| Citrates | 0.8% |
| Color | 0.1% |
| Lactic acid | 0.02% |

### Comparative Example 2

A second comparative cheese powder composition (Powder 3) was prepared and applied to frozen broccoli pieces. Powder 3 was prepared by combining cheese, whey, and viscosity builders in the amounts shown in Table 4 below. Powder 3 combined three separate cheese powders in the powdered sauce. (Sequoia cheese powder, Chedasharp cheese powder, and Exceed Plus cheese powder are all commercially available from Kraft Foods). Powder 3 had about 21 percent fat, 4.8 percent whey protein, and about 11 percent casein. This formulation had a ratio of casein to whey of about 2.3:1 and included about 25.9 percent starches, gums, and viscosity builders (i.e., starch, sodium carboxymethyl cellulose, and maltodextrin). All of the ingredients were dry blended in a ribbon blender to create Powder 3.

TABLE 4
Formulation for Powder 3

| Ingredient | Amount |
|---|---|
| Sequoia cheese powder | 60% |
| Starch | 20% |
| Chedasharp cheese powder | 8% |
| Sodium carboxymethyl cellulose | 4% |
| Exceed Plus 4010 Cheese powder | 3% |
| Salt | 2% |
| Maltodextrin | 1.9% |
| Flavors | 1.3% |

Powder 3 was then sprinkled onto partially thawed individual broccoli pieces, in a ratio of about 10 percent powder to about 90 percent broccoli, based on total weight. The individually coated broccoli pieces were then heated in a microwave. Upon applying heat, Powder 3 was only partially hydrated by the moisture released from the broccoli pieces, resulting in an unacceptable, gloppy sauce. Upon closer inspection, the gloppy chunks of sauce were found to be partially hydrated on the outside, while their inner parts were still substantially in powder form.

### Example 2

A cheese powder composition (Powder 4) was prepared and applied to frozen broccoli pieces. Powder 4 was prepared by combining 2 parts of Powder 2 and 1 part of Powder 3 and mixing them together in a ribbon blender to form a granular, flowable powder. Powder 4 was then sprinkled onto partially thawed individual broccoli pieces, in a ratio of about 10 percent powder to about 90 percent vegetables, based on total weight. This powdered sauce has about 14.9 percent fat, about 6.2 percent whey protein, and about 12.3 percent casein. The formulation had a ratio of casein to whey of about 1.9:1, but only included about 8.5 percent starches, gums, and viscosity builders (i.e., starch, sodium carboxymethyl cellulose, and maltodextrin).

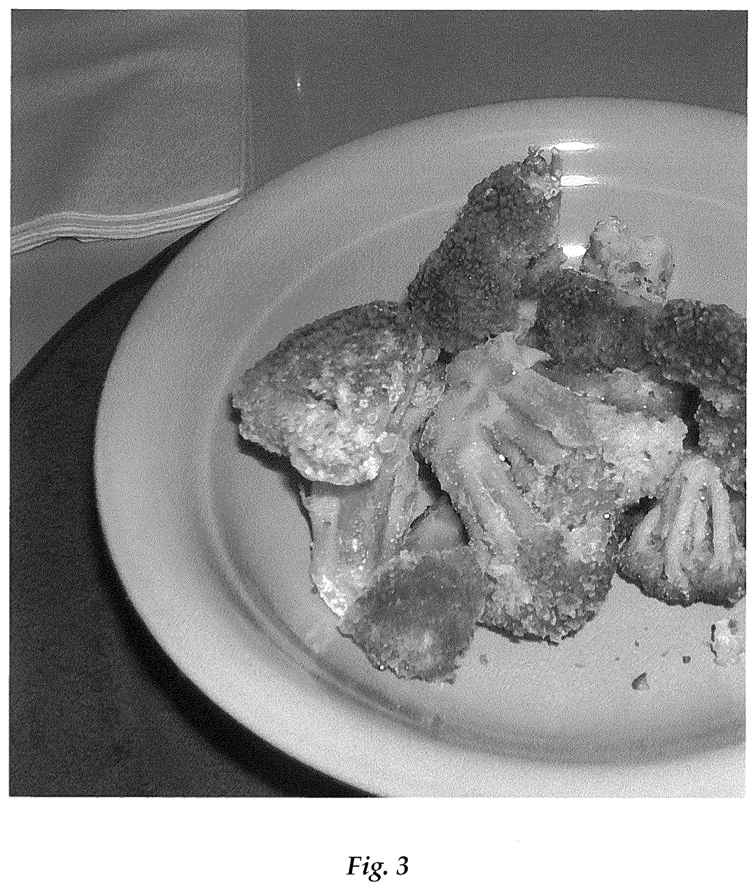

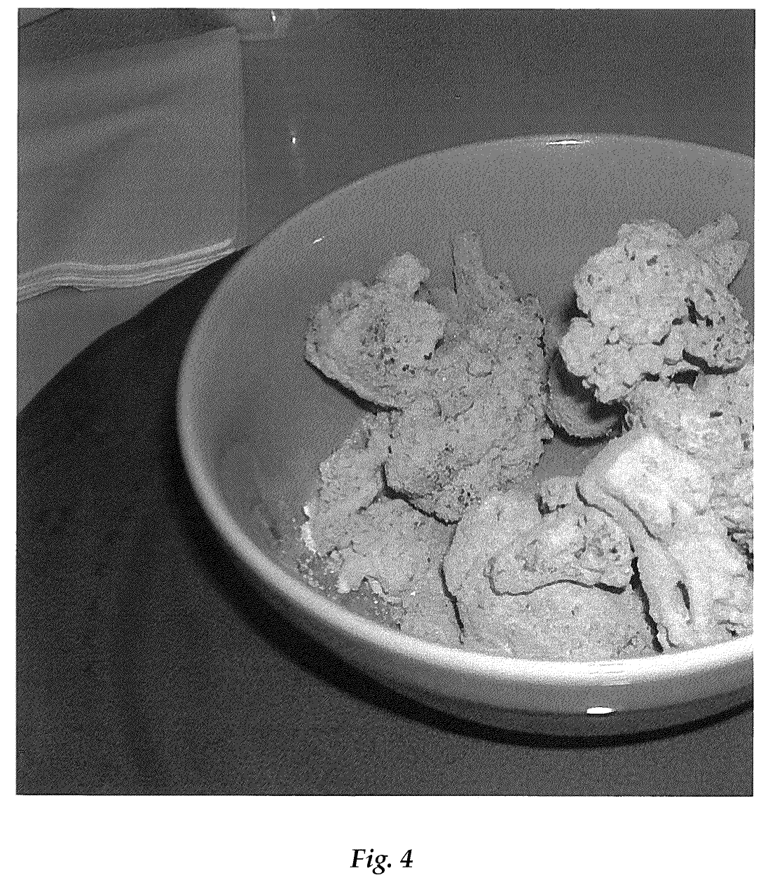

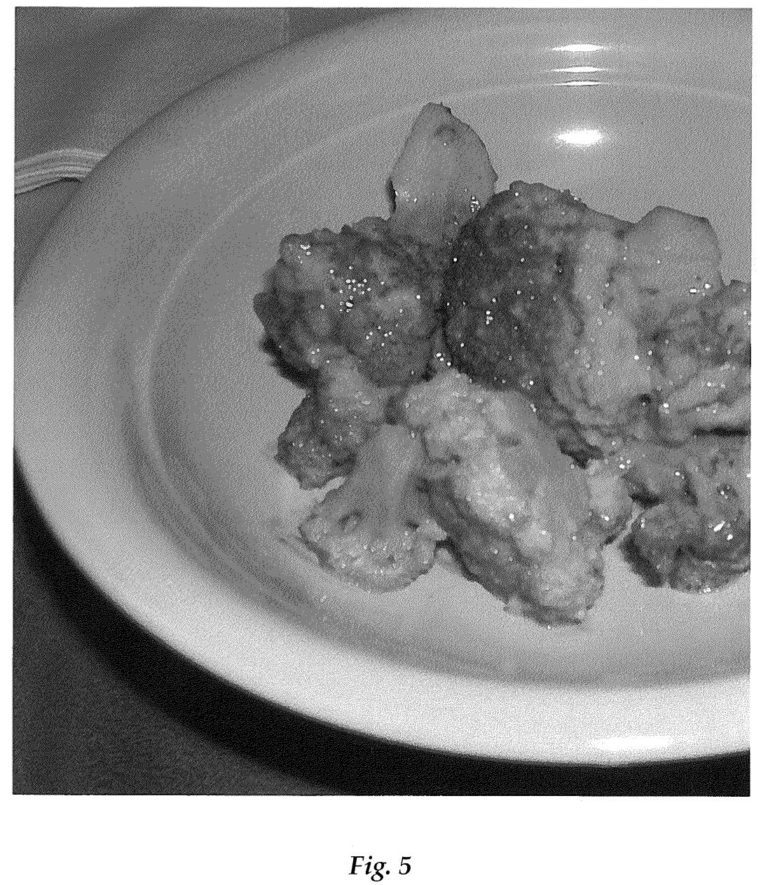

FIG. 3 shows the uncoated broccoli pieces. FIG. 4 shows the broccoli coated with Powder 4. FIG. 5 shows the broccoli after heating with the cheese sauce. The individually coated broccoli pieces were then heated in a microwave. Upon applying heat, the cheese powdered sauce was hydrated from the moisture released from the broccoli pieces, producing a cheese sauce of the desired consistency (i.e., FIG. 5) that substantially coated and adhered to each individual vegetable piece. No additional moisture was added during heating.

It will be understood that various changes in the details, materials, and arrangements of the process, formulations, and ingredients thereof, which have been herein described and illustrated in order to explain the nature of the method and resulting sauces, may be made by those skilled in the art within the principle and scope of the embodied method as expressed in the appended claims.

What is claimed is:

1. A frozen food suitable for heating to form a food and cheese-sauce combination without addition of water, the frozen food comprising:
a plurality of frozen food pieces each having an outer surface and an amount of frozen moisture associated therewith;
an amount of a powdered cheese composition adhered to the outer surface of each of the plurality of frozen food pieces; and
an amount of casein protein and an amount of whey protein in the powdered cheese composition in a ratio effective so that the powdered cheese composition can be hydrated to a fluid sauce during heating solely by the moisture in the frozen food piece when the powdered cheese composition includes between 0 and about 8.5 percent starches, gums, and viscosity builders.

2. The frozen food of claim 1, wherein the powdered cheese composition includes about 12 to about 26 percent casein protein and about 3 to about 12 percent whey protein with a ratio of the casein protein to the whey protein from about 4:1 to about 8:1 with no starches, gums, and viscosity builders.

3. The frozen food of claim 2, wherein each frozen food piece includes about 5 to about 15 weight percent powdered cheese composition to about 85 to about 95 weight percent frozen food.

4. The frozen food of claim 1, wherein the powdered cheese composition includes about 12 to about 26 percent casein protein and about 3 to about 12 percent whey protein with a ratio of the casein protein to the whey protein from about 2:1 to less than about 4:1 with about 8.5 percent or less starches, gums, and viscosity builders.

5. The frozen food of claim 4, wherein each frozen food piece includes about 5 to about 15 weight percent powdered cheese composition to about 85 to about 95 weight percent frozen food.

6. The frozen food of claim 1, wherein the plurality of frozen food pieces are selected from the group consisting of artichokes, beans, beets, broccoli, Brussels sprouts, carrots, cauliflower, corn, eggplant, leeks, peas, peapods, peppers, spinach, squash, tomatoes, zucchini, pasta, rice, potatoes, beef, chicken, fish, turkey, protein, and combinations thereof.

7. The frozen food of claim 1, wherein one of the frozen food and the powdered cheese composition is substantially free of adherants, oils, and fats for adhering the powdered cheese composition to the frozen food.

8. The frozen food of claim 1, wherein the powdered cheese composition has a moisture content of about 4 percent or less.

9. The frozen food of claim 8, further including about 12 to about 26 percent casein protein and about 3 to about 6 percent whey protein.

10. The frozen food of claim 9, further including about 14 to about 22 percent fat.

11. The frozen food of claim 10, wherein an interface between the frozen food and the powder cheese composition is substantially free of an oil layer.

12. A method of preparing a food and cheese-sauce meal, the method comprising:
providing a plurality of frozen food pieces each of which have an outer surface and an amount of frozen moisture;
applying to the outer surface of each of the plurality of frozen food pieces a powdered cheese composition such that each frozen food piece is substantially uniformly coated with the powdered cheese composition, the powdered cheese composition including amounts of casein protein and amounts of whey protein in a ratio effective so that the powder cheese composition can be hydrated to a fluid sauce during reheating solely by the moisture in the frozen food pieces when the powdered cheese composition includes between 0 and about 8.5 percent starches, gums, and viscosity builders;
selecting a portion of the coated frozen food pieces; and
applying heat to the portion of the plurality of frozen food pieces so that the frozen moisture of the frozen food piece hydrates the powdered cheese composition into a fluid sauce without adding additional moisture.

13. The method of claim 12, wherein the powdered cheese composition includes about 12 to about 26 percent casein protein and about 3 to about 12 percent whey protein with a ratio of the casein protein to the whey protein from about 4:1 to about 8:1 with no starches, gums, and viscosity builders.

14. The method of claim 13, wherein the applying includes applying to each frozen food piece about 5 to about 15 weight percent powdered cheese composition to about 85 to about 95 weight percent frozen food.

15. The method of claim 12, wherein the powdered cheese composition includes about 12 to about 26 percent casein protein and about 3 to about 12 percent whey protein with a ratio of the casein protein to the whey protein from about 2:1 to less than about 4:1 with about 8.5 percent or less starches, gums, and viscosity builders.

16. The method of claim 4, wherein the applying includes applying to each frozen food piece about 5 to about 15 weight percent powdered cheese composition to about 85 to about 95 weight percent frozen food.

17. The method of claim 12, wherein the plurality of frozen food pieces are selected from the group consisting is selected from the group consisting of artichokes, beans, beets, broccoli, Brussels sprouts, carrots, cauliflower, corn, eggplant, leeks, peas, peapods, peppers, spinach, squash, tomatoes, zucchini, pasta, rice, potatoes, beef, chicken, fish, turkey, protein, and combinations thereof.
